(19) United States
(12) Patent Application Publication
(10) Pub. No.: US 2005/0136388 A1
(43) Pub. Date: Jun. 23, 2005

(54) System and method for providing instructional data integrity in offline e-learning systems

(75) Inventors: Charles P. de Saint-Aignan, Cambridge, MA (US); Fernando Salazar, Arlington, MA (US)

Correspondence Address: CHRISTOPHER & WEISBERG PA, 200 E LAS OLAS BLVD, SUITE 2040, FT LAUDERDALE, FL, 33301, US

(73) Assignee: International Business Machines Corporation, Armonk, NY (US)

(21) Appl. No.: 10/741,731

(22) Filed: Dec. 19, 2003

(51) Int. Cl. G09B 3/00

(52) U.S. Cl. 434/350

(57) ABSTRACT

The present invention is a system and method for maintaining the integrity of data during the offline mode of an e-learning process. The invention maintains the integrity of online course material in a learning management system by determining when a student attempts to access online course material and to downloaded the material from a learning management server to a student server for offline utilization resulting in an offline access mode. The invention then provides a set of procedures for monitoring the course material when it has been accessed. The set of procedures may determine that the course material is in an offline access mode and prevent the student from accessing the course object from the learning management server while the course object is in the offline access mode. Further, the system and method of the present invention may also serve to synchronize the course material between the learning management server and the student server by copying the course material from one server to another. In one embodiment, the system and method of the present invention can prevent a student from uploading the course material to the learning management server unless the student has completed the one or more progress objectives associated with the course object. Finally, the set of procedures can provide a security mechanism to insure the security of the online course material when it is in the offline access mode.

### BACKGROUND OF THE INVENTION

1. Statement of the Technical Field

The present invention relates to on-line learning management systems and, in particular, to insuring instructional integrity of data at all times during the offline mode of a learning management system.

2. Description of the Related Art

Learning management systems provide for the total management of an on-line learning experience—from content creation to course delivery. A properly organized learning management system is an educational program that allows students to partake in a “classroom” setting from their own home via the Internet. In the prototypical learning management system, one or more course offerings can be distributed about a computer communications network for delivery to students enrolled in one or more corresponding courses. The course offerings can include content which ranges from mere text-based instructional materials to full-blown interactive, live classroom settings hosted entirely through the computer communications network. So advanced to date has the ability of learning management systems to deliver content become, that nearly any learning experience formerly delivered through in-person instruction now can be delivered entirely on-line and even globally over the Internet.

The conventional learning management system can include a learning management server configured to manage the introduction and distribution of course materials to enrolled students. The learning management server further can be configured to import course content and the structure and arrangement of the course content created both by coupled authoring tools and third party authoring tools which can package course content according to any one of the well known course content packaging standards, such as the ADL Shareable Content Object Reference Model (SCORM) and AICC. Once imported, online course objects can be created based upon a course master reflecting the packaged course content and metadata describing the structure and arrangement of the course content. The on-line course object can be cataloged for public availability to registered students and the content reflected within the on-line course instances can be distributed to the students on-demand.

A learning management system consists of an “online” mode and an “offline” mode. The online mode allows the student to answer questions in “real time”, along with other students in a “virtual” classroom setting. There are times, however, when the student may want to utilize the “offline” mode of the learning management system if they are unable to “attend” the class at the required time. This, however, may compromise the integrity of the learning management system program.

More particularly, when a student partakes in the offline mode of a learning management system, course materials are copied onto the student's local computer for later access without the requirement that the student be connected to the learning management server. One problem with allowing the student to access course material in this fashion is that the student is able to take the course simultaneously online, thereby allowing him or her to view the correct answers to assessments in one mode (online) and use it in the other mode (offline).

Another problem that can potentially compromise the integrity of the learning management system is that the student can take the course in the offline mode without transmitting progress data to the learning management host and then simply take the course online with knowledge of test questions and answers. Finally, allowing a student to take a course in the offline mode raises the question of security with respect to the data that is transferred to the student's machine. It is therefore desirable to have a method and system that ensures the integrity of data in the offline mode of a web-based instructional e-learning model.

### SUMMARY OF THE INVENTION

The present invention addresses the deficiencies in the art with respect to efficiently monitoring online course materials that are copied onto a student's computer during the offline utilization of the course materials in a learning management system setting and provides a novel and non-obvious method and system for ensuring the integrity of the course materials in an interactive learning management system program.

Methods consistent with the present invention provide a method for maintaining integrity of course data during offline utilization of a learning management system. The method includes determining when a student attempts to access a course object from a host server in an online access mode for offline utilization thereby creating an offline access mode for that student. The method then implements a set of procedures for monitoring the course object when the student attempts to access the course object from the host server.

Systems consistent with the present invention include a system for maintaining integrity of course data during offline utilization of a learning management system when the course object is in an offline access mode. The system includes a learning management database configured to store an online course object in an online access mode, and a learning management server coupled to the database. The learning management server includes a set of procedures for monitoring the course object when a student attempts to download the course object from the learning management server to a student server resulting in an offline access mode.

In accordance with still another aspect, the present invention provides a computer-readable storage medium storing a computer program which when executed maintains the integrity of course data during offline utilization of a learning management system. The computer program determines when a student attempts to access a course object from a host server in an online access mode for offline utilization thereby creating an offline access mode for that student. The computer then implements a set of procedures for monitoring the course object when the student attempts to access the course object from the host server.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of the this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a learning management system configured to allow access to online course objects by one or more client computing devices;

FIG. 2 is a flow chart illustrating how the present invention manages the process of accessing an online course object for offline utilization;

FIG. 3 is a flow chart illustrating how the present invention manages the process of launching an online course object from the learning management server; and

FIG. 4 is a flow chart of a process for implementing a security mechanism to insure the integrity of data downloaded from a learning management server.

### DETAILED DESCRIPTION OF THE PREFERRED EMBODIMENTS

The present invention is a method and system for maintaining the integrity of data during the offline mode of an e-learning process. In an e-learning process such as a Learning Management System (LMS), the present invention can be employed to prevent students from achieving an unfair advantage in the classroom by utilizing the “offline” mode of a particular LMS course in order to gain access to information and using that information to the student's advantage when returning to the “online” mode.

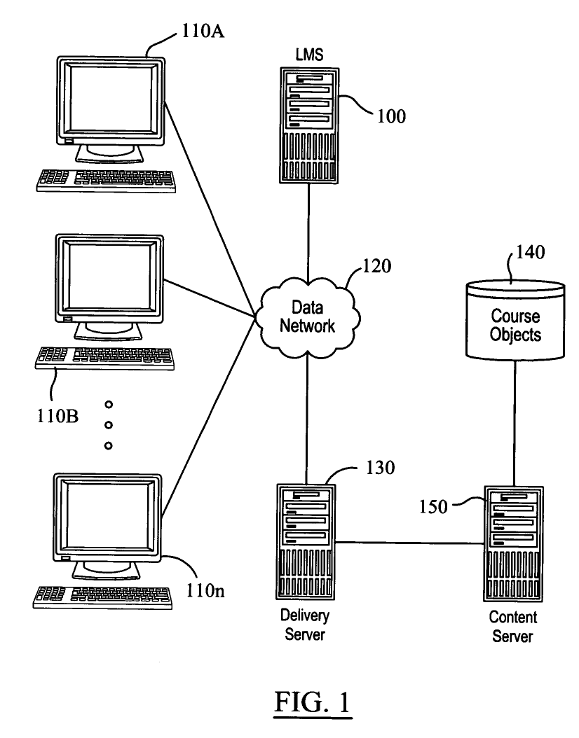

Referring now to the drawing figures in which like reference designators refer to like elements, there is shown in FIG. 1 a schematic illustration of the components in a typical web-based LMS e-learning model. The LMS includes a learning management server 100 coupled to one more client computing devices 110A, 110B, 110n, over a computer communications network 120. The learning management server 100 can include a database management system (not shown) to manage users, enrollment, course catalog and resources. Further, the learning management server 100 can include reporting, calendaring, messaging and scheduling logic.

Students can search the course catalog on the learning management server 100 to locate a specific online course object. Once a desired course object has been located, the students can enroll in the course. Responsive to the enrollment, the students can access the content for the selected course object in a designated delivery server 130. More particularly, delivery server 130 can be coupled to learning management server 100 over the data communications network 120. The delivery server 130 can be configured to render a user interface for the delivery of course objects 140 to clients 110A, 110B, 110n over the data communications network 120. In this regard, a communicatively coupled content server 150 can serve course objects 140 to the clients 110A, 110B, 110n at the behest of the delivery server 130.

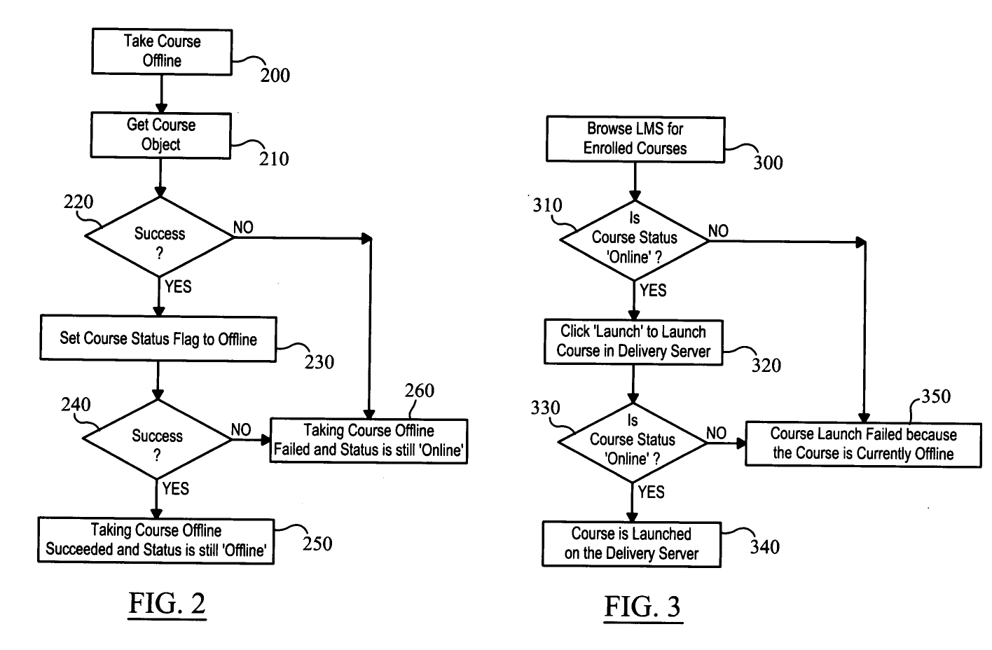

Notably, students can access the specific online course object in one of an online mode, or an offline mode. To permit students to access the specific online course object in an offline mode, however, can introduce the opportunity to breach the integrity of the online learning experience. One way of insuring the integrity of an e-learning program is to insure that when a student wishes to access a course object in an “offline” mode, that student is prevented from simultaneously accessing course materials online. Similarly, when the student wants to return to the “online” mode he or she is then prevented from accessing the same course materials offline. This process is shown in the flow chart of FIG. 2.

Referring to FIG. 2, when a student wants to access a course in an LMS program in an offline mode (step 200), he or she initiates a transaction that obtains a course object (course material and metadata) and delivers the course object to the student's local computer (step 210). The invention also allows the student to choose which specific activities within a course object may be accessed offline. For example, if the course includes information about religions in Asia, the student may wish to only access information discussing religions in India, before accessing information regarding other countries in Asia. In this instance, only the selected learning activities are downloaded to the user's computer.

The present invention assigns bit indicators to the selected course object in order to flag its status, e.g. either “offline” or “online”. When a course object or specific activities within a course object are successfully taken offline (step 220), the system of the present invention flags that course object as being in an offline state (step 230). The learning management server 100 records the status of the course object with respect to that particular student. Only when the learning management server recognizes that an offline status flag has been successfully generated for a particular enrollment (i.e. the “union” of a student and a course object) (step 240) is the student allowed to download the course object (step 250). Unsuccessful generation of the offline flag results in the course object still being designated as “online” (step 260). Before allowing a student to access a course object in the offline access mode, the system of the present invention first checks the flag and if the flag indicates that the course is in an online mode, the system prevents any further attempts by the student to access the course object for offline utilization. The delivery server 130 (shown in FIG. 1) is notified by both the learning management server 100 and the client's server when a status change has occurred.

The present invention also prevents a student from accessing a course object online, while that course object is still in an offline access mode. This prevents students from obtaining answers to course questions while offline, and then, while still having access to the course material, entering the online mode with pre-knowledge of the course material. FIG. 2 illustrates the process of launching a course online from the learning management system. A student browses the learning management system directory and selects a course (step 300). The system then queries the learning management server 100 to determine if the selected course is available online (step 310).

If the learning management server determines that the course is available online, the student selects the course, and the delivery server 130 is notified (step 320). The delivery server 130 is then checked to determine if the selected course has been flagged for “online” status (step 330). If the course is flagged as an online course (i.e. it is not currently offline), the course is launched on the delivery server (step 340) and may be accessed by the student online. If the course is flagged as an offline course, the course cannot be launched until the course status reverts back to an “online” status (step 350). The LMS host manager has the option of overriding this mode in certain instances, thereby removing the online/offline exclusionary restriction.

In another embodiment, the method and system of the present invention insures the integrity of e-learning material via the synching of progress information between the online and the offline servers at the application layer rather than at a lower level such as the database layer. The system of the present invention provides Java objects, representing tables in the online database, to allow for easy manipulation and synchronization of data objects. The present invention provides the ability for the learning management system manager to synchronize the online server (the LMS server) with the offline server (the student's computer) by copying all the course data from one server to another. In this fashion, the LMS manager can observe progress by the student as he or she progresses in the offline mode.

In another embodiment, the present invention synchronizes online and offline data uploads by connecting the data uploaded by a student to the course progress rollup process so that the upload process captures checkpoints at the course activity level and then uploads only those checkpoints. Therefore, an LMS course can be designed to insure that a course can be uploaded only after a certain, defined set of activities were completed.

For example, courses on a delivery server 130 of a typical learning management system are typically stored in a tree structure, where each activity in a course contains progress information. Certain activities in the tree structure require a rollup process whereby scores are computed (via SCORM standards) and these scores recursively make their way up the tree structure and modify the progress records of the parent activities as necessary. Students must complete a set of tasks or achieve a certain score on a lower-level activity before moving on to the next, higher-level activity. Advantageously, the present invention can require that students in the offline access mode periodically upload their course progress status, insuring that certain tasks have been completed before being allowed to access the next course object in the hierarchal tree structure.

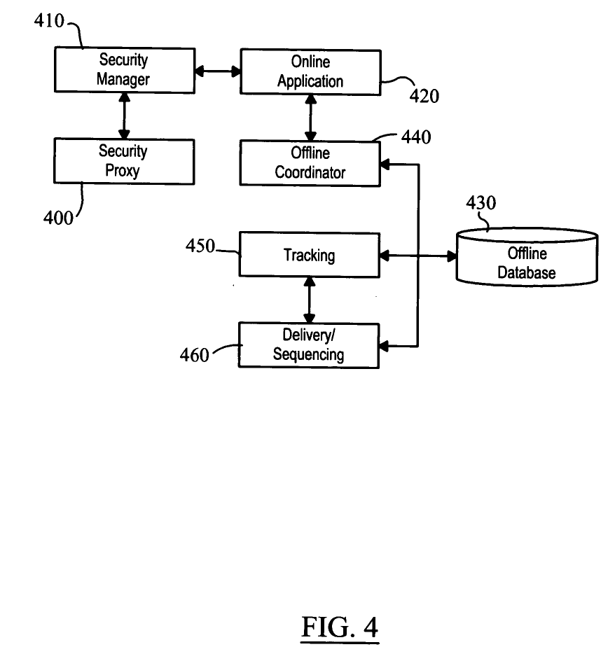

In yet another embodiment, the present invention provides a security mechanism that can be implemented on the student's server in order to protect the data during transmission and when the student is in offline mode. The security mechanism can be installed at one or more locations between the host server and the student server. For example, referring to FIG. 4, a first option could be to provide a security proxy 400 on the student server that communicates directly with a security manager 410 on the LMS server for a particular online application 420. The security proxy 400 contains the information necessary to authenticate the user of the student application in an interactive LMS session. For example, the student may be required to fill out a certificate of authentication that must be verified before that student can continue with his or her session. Blocks 440-460 manage the transfer of data between servers. This option ensures security of data during transmissions between the online (LMS) server and the offline (student) server 430.

When a student takes a learning session to the “offline” mode, the security proxy 400 can also be granted a token. The token can be in the form of an encryption key used for encrypting the data before it is sent back to the LMS server. In this fashion, a malicious user cannot corrupt course data and upload it to the LMS server. This preserves the integrity of the data. The security proxy 400 is programmable thereby allowing the LMS course designer to vary the implementation and effect of the security features. An alternate or additional location for the security mechanism of the present invention may be in the offline database itself to insure that the actual data in the offline client server is secure. The database can be secured, for example, using global encryption on the data contained therein. A password may be generated during packaging of the student application, before the database is installed on the student's computer. In one embodiment, the offline database can only be accessed through the actual binary code that is used to access it.

The present invention advantageously provides a system and method for maintaining the integrity of data transmitted between a student's server and a learning management system server by implementing a set of procedures during the data transmission process. The procedures that are implemented may be logic parameters that limit a course object to either an online status of an offline status, or a synchronization process between servers to allow a course designer to monitor what progress a student has made and to assure that the student is returned to the online curriculum in a proper location. Finally, a set of security measures may be implemented which prevents data downloaded from the online server to the student's offline database from being manipulated and/or corrupted prior to its uploading back to the online server.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system having a central processing unit and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computer system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

1. A method for maintaining integrity of course data during offline utilization of a learning management system, the method comprising:
determining when a student attempts to access a course object from a host server in an online access mode for offline utilization thereby creating an offline access mode for that student; and
implementing a set of procedures for monitoring the course object when the student attempts to access the course object from the host server.

2. The method of claim 1 wherein implementing a set of procedures comprises:
determining if the course object is still in the offline access mode; and
preventing the student from accessing the course object from the host server while the course object is in the offline access mode.

3. The method of claim 2, wherein after the course object has been returned to the online access mode, preventing the student from re-accessing the course object for offline utilization while the course object is in the online access mode.

4. The method of claim 1, wherein implementing a set of procedures comprises copying the course object after it has been downloaded to a student server for offline utilization to the host server to provide synchronization of the course object between servers.

5. The method of claim 1, wherein implementing a set of procedures comprises copying the course object from the host server to a student server to provide synchronization of the course object between servers.

6. The method of claim 1, wherein implementing a set of procedures comprises:
determining if the student has completed one or more objectives associated with the course object when in the offline access mode; and
preventing the student from re-accessing the course object in the online access mode unless the student has completed the one or more objectives associated with the course object.

7. The method of claim 1, wherein implementing a set of procedures comprises providing a security mechanism for preventing unauthorized manipulation of the course object when in the offline access mode.

8. The method of claim 7, wherein the security mechanism is located between a student server and the host server.

9. The method of claim 7, wherein the security mechanism resides in the student server.

10. A computer-readable storage medium storing a computer program which when executed performs a method for maintaining integrity of course data during offline utilization of a learning management system, the computer program comprising determining when a student attempts to access a course object from a host server in an online access mode for offline utilization thereby creating an offline access mode for that student, and implementing a set of procedures for monitoring the course object when the student attempts to access the course object from the host server.

11. The computer-readable storage medium of claim 10 wherein implementing a set of procedures comprises:
determining if the course object is still in the offline access mode; and
preventing the student from accessing the course object from the host server while the course object is in the offline access mode.

12. The computer-readable storage medium of claim 11, wherein the method performed by the stored computer program when executed further includes preventing the student from re-accessing the course object for offline utilization while the course object is in the online access mode.

13. The computer-readable storage medium of claim 10, wherein implementing a set of procedures comprises copying the course object after it has been downloaded to a student server for offline utilization to the host server to provide synchronization of the course object between servers.

14. The computer-readable storage medium of claim 10, wherein implementing a set of procedures comprises copying the course object from the host server to a student server to provide synchronization of the course object between servers.

15. The computer-readable storage medium of claim 10, wherein implementing a set of procedures comprises:
determining if the student has completed one or more objectives associated with the course object when in the offline access mode; and
preventing the student from re-accessing the course object in an online access mode unless the student has completed the one or more objectives associated with the course object.

16. The computer-readable storage medium of claim 10, wherein implementing a set of procedures comprises providing a security mechanism for preventing unauthorized manipulation of the course object when in the offline access mode.

17. The computer-readable storage medium of claim 16, wherein the security mechanism is located between a student server and the host server.

18. The computer-readable storage medium of claim 16, wherein the security mechanism resides in the student server.

19. A system for maintaining integrity of course data during offline utilization of a learning management system when the course object is in an offline access mode, the system comprising:
a learning management database configured to store an online course object in an online access mode; and
a learning management server coupled to the database, the learning management server comprising a set of procedures for monitoring the course object when a student attempts to download the course object from the learning management server to a student server resulting in an offline access mode.

20. The system of claim 19 wherein the set of procedures comprises logic for determining if the course object is still in the offline access mode, and for preventing the student from accessing the course object from the host server while the course object is in the offline access mode.

21. The system of claim 20, wherein after the course object has been returned to the online access mode, the logic prevents the student from re-accessing the course object for offline utilization while the course object is in the online access mode.

22. The system of claim 19, wherein the set of procedures copies the course object after it has been downloaded to the student server for offline utilization to the learning management server to provide synchronization of the course object between servers.

23. The system of claim 19, wherein the set of procedures copies the course object from the learning management server to the student server to provide synchronization of the course object between servers.

24. The system of claim 19, wherein the set of procedures comprises logic for determining if the student has completed one or more objectives associated with the course object when in the offline access mode, and for preventing the student from re-accessing the course object in the online access mode unless the student has completed the one or more objectives associated with the course object.

25. The system of claim 19, further comprising a security mechanism for preventing unauthorized manipulation of the course object when in the offline access mode.

26. The system of claim 25, wherein the security is located between the student server and the learning management server.

27. The system of claim 25, wherein the security mechanism resides in the student server.
